(19) United States
(12) Patent Application Publication
(10) Pub. No.: US 2014/0026451 A1
(43) Pub. Date: Jan. 30, 2014

(54) SIGNAGE APPARATUS

(71) Applicant: Ligon Lee Gillespie, Salisbury, NC (US)

(72) Inventor: Ligon Lee Gillespie, Salisbury, NC (US)

(21) Appl. No.: 13/556,440

(22) Filed: Jul. 24, 2012

(51) Int. Cl. G09F 21/04; B23P 11/00; G09F 13/04

(52) U.S. Cl. 40/578; 29/525.01; 29/426.1

(57) ABSTRACT

A signage apparatus includes a plug-in hitch, a slack adjuster bracket, a water-resistant sign box, and an upright post. The plug-in hitch includes opposed plates and an insert portion configured for receipt within a hitch receiver. The upright post includes a plurality of openings defined therethrough sized and dimensioned for receipt of a securement member, and positioned to correspond to a plurality of openings of the opposed plates when the upright post is received between the opposed plates. The plurality of openings include lower openings configured for coupling of the upright post to the plug-in hitch via a securement member such that the upright post is capable of rotative movement relative to the plug-in hitch about an axis defined by the securement member, such rotative movement being limited by the insert portion of the plug-in hitch.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to signage apparatus. Although various signage apparatus exist for the display of signs, various needs still exist for improvement in apparatus, systems, and methods for displaying signage. These, and other needs, are addressed by one or more aspects of the present invention.

### SUMMARY OF THE INVENTION

The present invention includes many aspects and features. Moreover, while many aspects and features relate to, and are described in, the context of a signage apparatus secured to a vehicle, the present invention is not limited to use only in such context, as will become apparent from the following summaries and detailed descriptions of aspects, features, and one or more embodiments of the present invention.

Accordingly, one aspect of the present invention relates to a signage apparatus comprising a plug-in hitch component, a slack adjuster bracket component, a water-resistant sign box, and an upright post component. The plug-in hitch component includes opposed plates, the opposed plates each including a plurality of openings defined therethrough sized and dimensioned for receipt of a securement member, and an insert portion configured for receipt within a hitch receiver. The slack adjuster bracket component includes a first securement bolt configured for use in securing the slack adjuster bracket to the hitch receiver, and a second securement bolt configured for use in securing the slack adjuster bracket component to the plug-in hitch component. The water-resistant sign box is configured for receipt of a sign therein, and includes a base comprising a water resistant sealant strip disposed on a first side thereof and a mounting channel defined on a second side thereof, a lid rotatively coupled to the base via one or more hinges, and a lighting element. The lid includes a generally transparent protective sheet. The water resistant sealant strip is positioned and configured to seal the water-resistant sign box when the water-resistant sign box is closed. The upright post component is sized and dimensioned to be received both between the opposed plates of the plug-in hitch component and the mounting channel of the water-resistant sign box, and is configured for attachment of the water-resistant sign box thereto following insertion of the upright post into the mounting channel of the water-resistant sign box. The upright post component includes a plurality of openings defined therethrough sized and dimensioned for receipt of a securement member, and positioned to correspond to the plurality of openings of the opposed plates of the plug-in hitch component when the upright post component is received between the opposed plates of the plug-in hitch component. The plurality of openings of the opposed plates of the plug-in hitch component and the plurality of openings of the upright post component include lower openings configured for coupling of the upright post component to the plug-in hitch component via a securement member such that the upright post component is capable of rotative movement relative to the plug-in hitch component about an axis defined by the securement member, such rotative movement being limited by the insert portion of the plug-in hitch component.

In a feature of this aspect, the lightning element comprises an LED panel.

In a feature of this aspect, the water-resistant sign box includes an electrical connector for quick connection of the water-resistant sign box to electrical power. In at least some implementations, the electrical connector connects through the four prong standard trailer connector, while in at least some other implementations the connector connects to a 12 v DC connection inside a vehicle.

In a feature of this aspect, the water-resistant sign box includes a battery.

In a feature of this aspect, the generally transparent protective sheet of the lid comprises generally clear polycarbonate resin thermoplastic.

In a feature of this aspect, the water-resistant sign box comprises aluminum.

In a feature of this aspect, the mounting channel of the water-resistant sign box is defined by two L-shaped fastening pieces.

In a feature of this aspect, the base of the water-resistant sign box comprises a sheet of aluminum glued to an aluminum frame.

In a feature of this aspect, the generally transparent protective sheet of the lid of the water-resistant sign box is glued to an aluminum frame of the lid.

In a feature of this aspect, the openings sized and dimensioned for receipt of a securement member are sized and dimensioned for receipt of a quick pin.

In a feature of this aspect, the openings sized and dimensioned for receipt of a securement member are sized and dimensioned for receipt of a bolt.

In a feature of this aspect, the signage apparatus is secured to a vehicle.

In at least some implementations, the signage apparatus is secured to an SUV.

In at least some implementations, the signage apparatus is secured to a pickup truck.

In at least some implementations, the signage apparatus is secured to a sedan.

In at least some implementations, the signage apparatus is secured to a vehicle that provides a receiver style hitch.

Another aspect of the present invention relates to a method. The method includes sliding a slack adjuster bracket component of a signage apparatus onto a hitch receiver of a vehicle such that first and second securing bolts of the slack adjuster bracket component are disposed on opposite sides of a protruding rim of the hitch receiver; securing the slack adjuster bracket component of the signage apparatus to the hitch receiver by tightening one of the securing bolts; sliding an insert portion of a plug-in hitch component of the signage apparatus into the hitch receiver; disposing a first extent of an upright post component of the signage apparatus within a mounting channel of a sign box of the signage apparatus; securing the upright post component of the signage apparatus to the sign box of the signage apparatus; securing a license plate to the upright post component of the signage apparatus; disposing a second extent of the upright post component of the signage apparatus between opposed plates of the plug-in hitch component of the signage apparatus; and coupling the upright post component of the signage apparatus to the plug-in hitch component of the signage apparatus via insertion of one or more securement members through openings defined through the upright post component and plug-in hitch component, at least some of the openings being configured to allow for rotative movement of the upright post component relative to the plug-in hitch component about an axis defined by a securement member inserted through those openings.

Another aspect of the present invention relates to a method for a system comprising a vehicle and a signage apparatus attached to the vehicle which includes a sign box, a plug-in hitch component, and an upright post component, both the plug-in hitch component and upright post component including a plurality of openings configured to allow for coupling of the two components to one another, the openings including lower openings configured to allow for rotative movement of the upright post component relative to the plug-in hitch component about an axis defined by a securement member inserted through the lower openings. The method includes removing a first securement member disposed through openings other than the lower openings, removal of the first securement member leaving only a second securement member coupling the upright post-component and plug-in hitch component together such that the second securement member allows for rotative movement of the upright post component relative to the plug-in hitch component about an axis defined by the second securement member; and opening an access way at a rear of the vehicle.

In a feature of this aspect, the vehicle comprises a pickup truck, and the access way comprises a tailgate of the pickup truck.

In a feature of this aspect, the access way comprises a tailgate.

In a feature of this aspect, the access way comprises a rear door of the vehicle.

In a feature of this aspect, the access way comprises a rear window of the vehicle.

In a feature of this aspect, the access way comprises the trunk of a sedan.

In a feature of this aspect, the access way comprises a rear hatch or door of a hatchback.

In addition to the aforementioned aspects and features of the present invention, it should be noted that the present invention further encompasses the various possible combinations and subcombinations of such aspects and features. Thus, for example, any aspect may be combined with an aforementioned feature in accordance with the present invention without requiring any other aspect or feature.

### BRIEF DESCRIPTION OF THE DRAWINGS

One or more preferred embodiments of the present invention now will be described in detail with reference to the accompanying drawings, wherein the same elements are referred to with the same reference numerals, and wherein,

FIG. 1 illustrates a truck with a trailer hitch receiver;

FIG. 2 illustrates a signage apparatus in accordance with a preferred embodiment of the present invention attached to a truck via a trailer hitch receiver;

FIG. 3 illustrates components of the signage apparatus of FIG. 2;

FIGS. 4A-B illustrate securement of a slack adjuster bracket to a trailer hitch receiver;

FIGS. 5A-B illustrate insertion of a plug-in hitch into a trailer hitch receiver and securement of the plug-in hitch to a slack adjuster bracket secured to the trailer hitch receiver;

FIG. 6 illustrates an upright post with a license plate secured thereto;

FIGS. 7-8 illustrate securement of an upright post to a plug-in hitch;

FIGS. 9A-B illustrate rotation of an upright post relative to a plug-in hitch;

FIG. 10 illustrates how rotation of an upright post relative to a plug-in hitch can enable opening of a tailgate of a pickup truck;

FIGS. 11-13 illustrate components of a sign box; and

FIG. 14 illustrates a sign box having a base and lid hingeably coupled to one another.

### DETAILED DESCRIPTION

As a preliminary matter, it will readily be understood by one having ordinary skill in the relevant art (“Ordinary Artisan”) that the present invention has broad utility and application. As should be understood, any embodiment may incorporate only one or a plurality of the above-disclosed aspects of the invention and may further incorporate only one or a plurality of the above-disclosed features. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

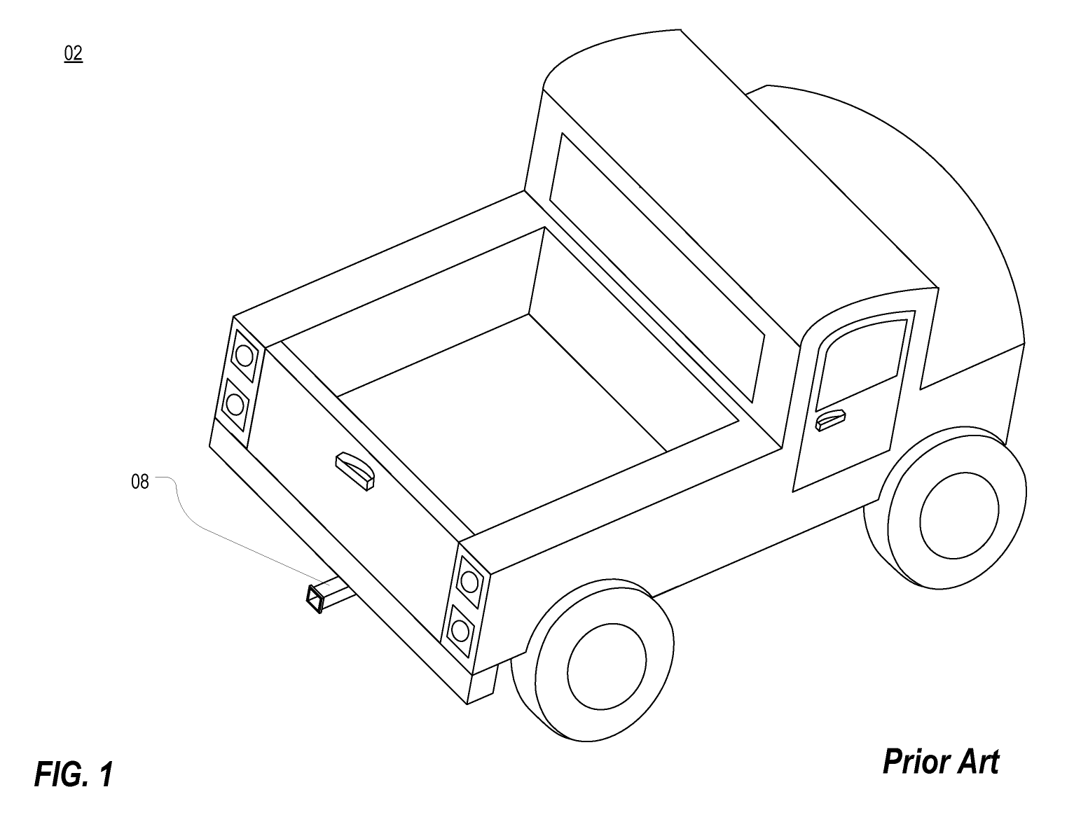

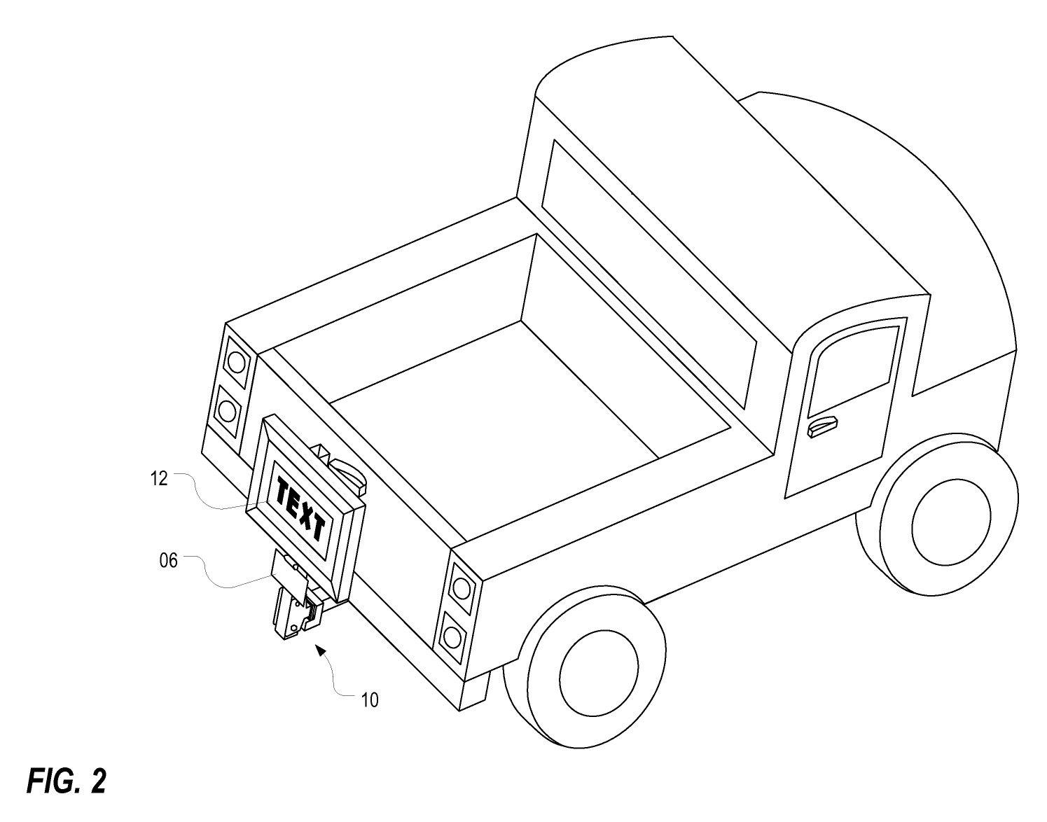

Turning now to the figures, FIG. 1 illustrates a truck 02 with a trailer hitch receiver 08.

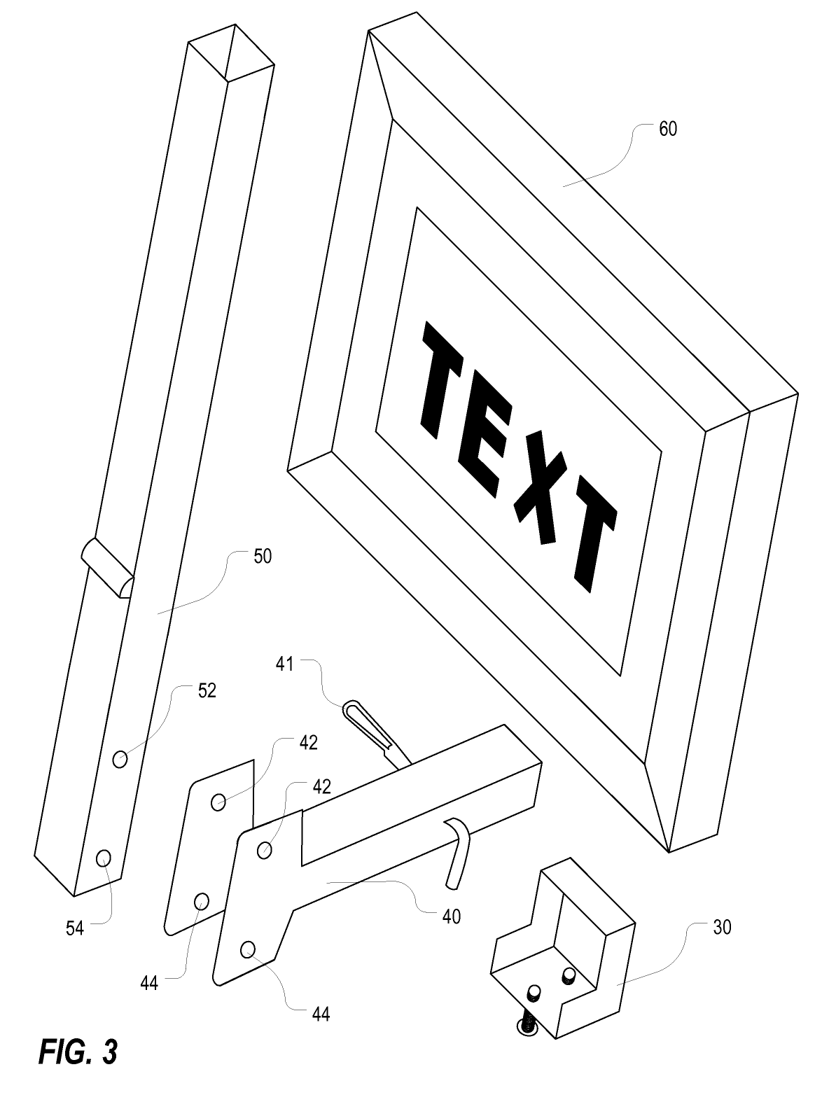

FIG. 2 illustrates a signage apparatus 10 in accordance with a preferred embodiment of the present invention attached to the truck 02 via the trailer hitch receiver 08. The signage apparatus 10 is configured to allow for display of a sign secured to, or within a sign box of, the signage apparatus 10. The signage apparatus 10 is further configured to allow for securement, and display, of a license plate.

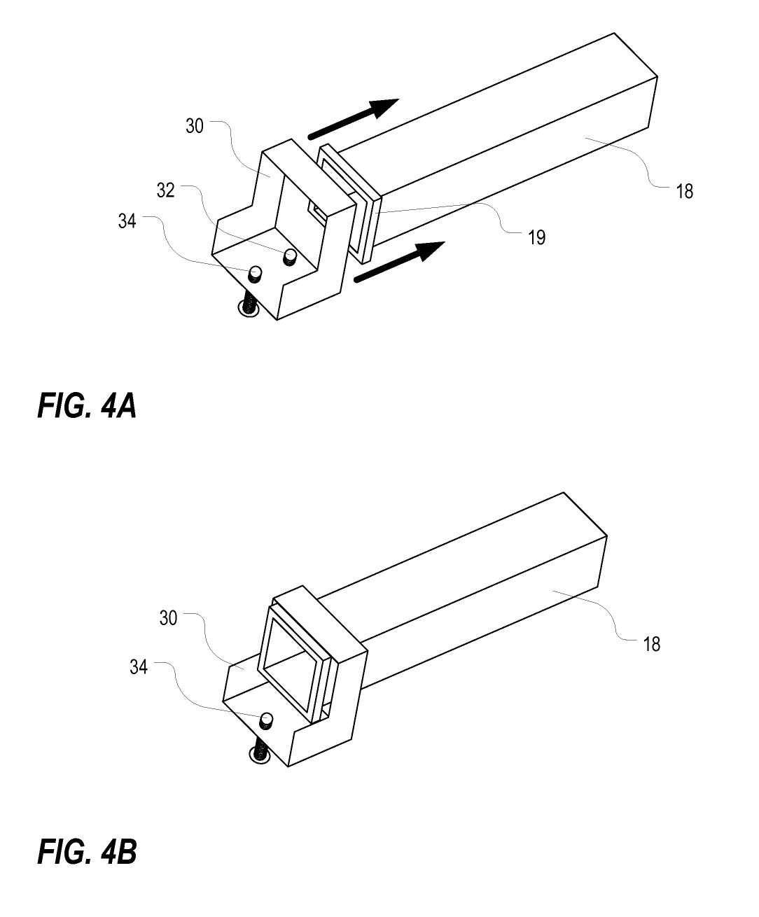

FIG. 3 illustrates components of the signage apparatus 10. The signage apparatus 10 includes a slack adjuster bracket 30, plug-in hitch 40, upright post 50, and sign box 60.

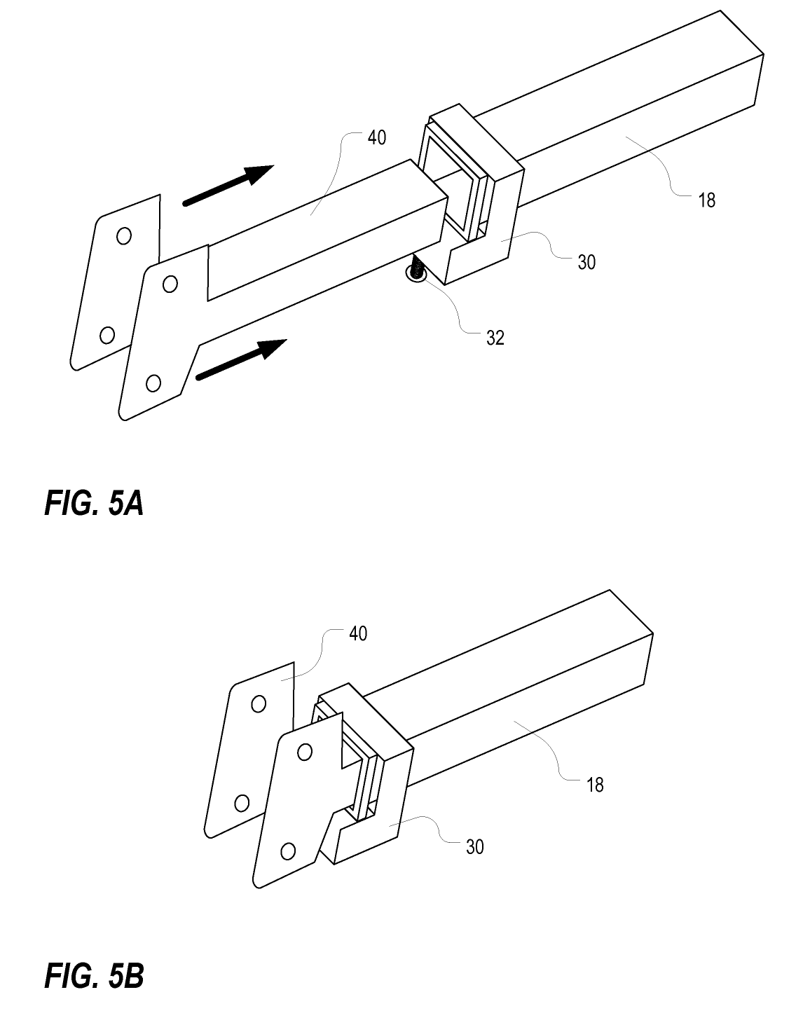

In order to secure the signage apparatus 10 to a hitch receiver, the slack adjuster bracket 30 is first slid onto a hitch receiver, as illustrated in FIG. 4A with hitch receiver 18. The slack adjuster bracket 30 preferably includes two securing bolts 32,34. The slack adjuster bracket is slid onto the hitch receiver 18 such that one of the securing bolts 34 is disposed beyond a protruding rim 19 of the hitch receiver 18, and then secured to the hitch receiver 18 via tightening of the securing bolt 34. FIG. 4B illustrates the slack adjuster bracket 30 so secured to the hitch receiver 18.

Thereafter, the plug-in hitch 40 is slid into the hitch receiver 18, as illustrated in FIG. 5A, and secured via tightening of the other securing bolt 32, such that it is secured as illustrated in FIG. 5B. In at least some preferred implementations, a pin or bolt, such as pin 41 illustrated in FIG. 3, may also be utilized to secure the plug-in hitch 40.

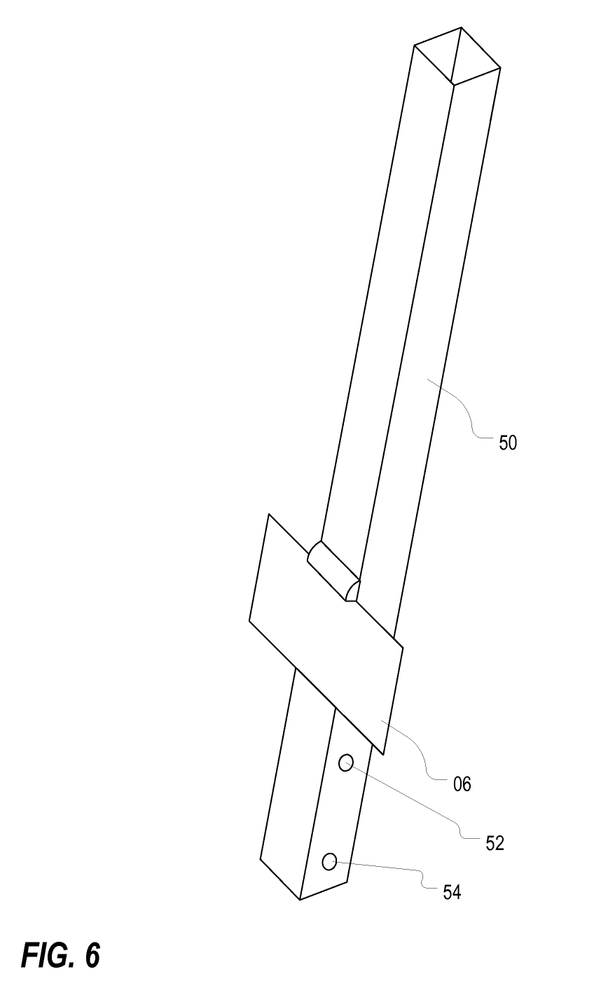

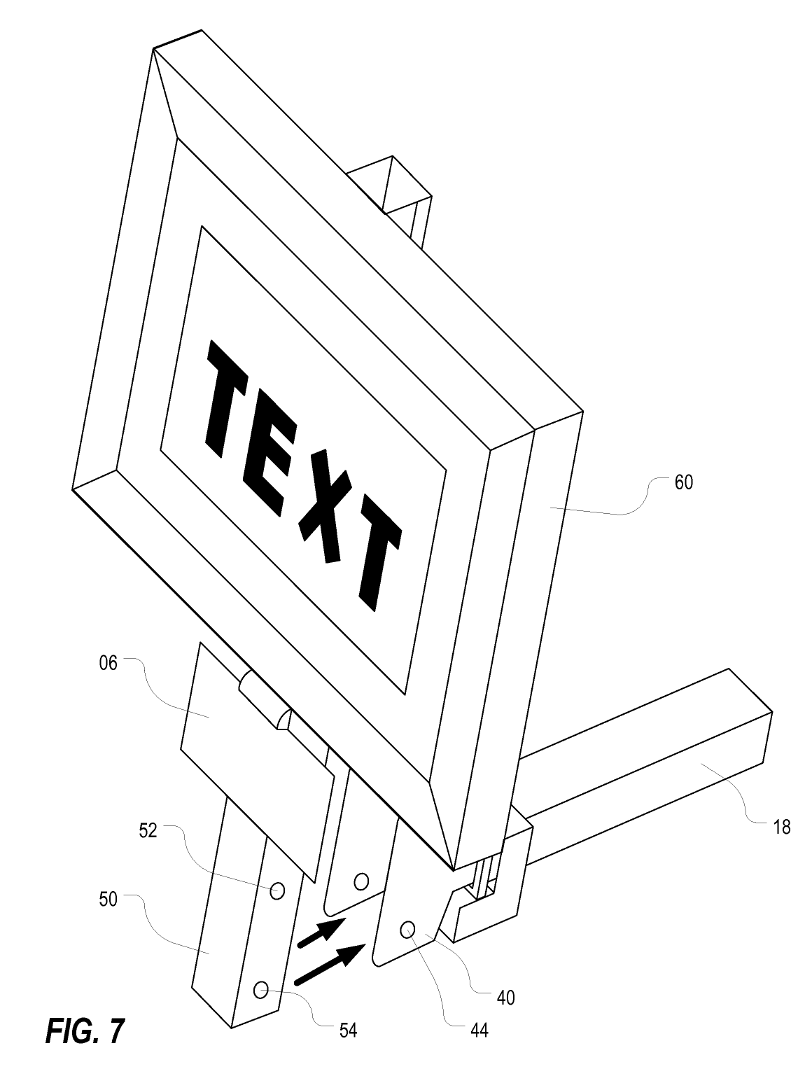

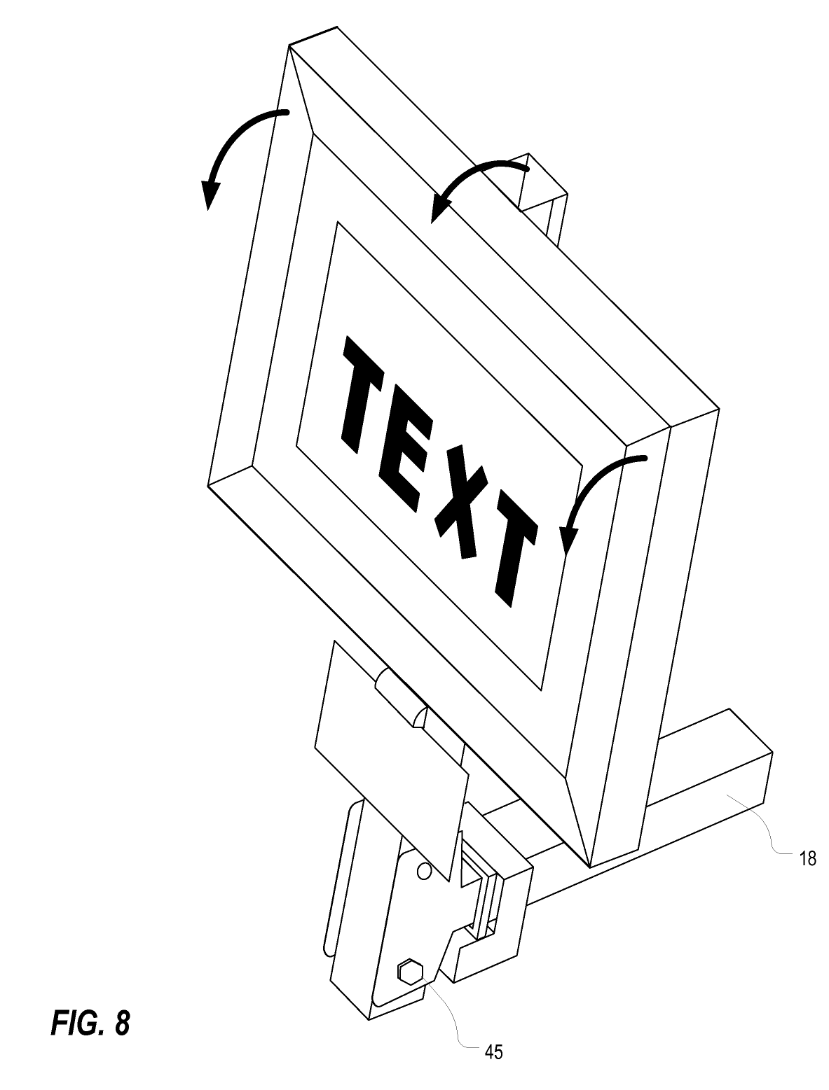

The plug-in hitch 40 is configured to allow for securement of the upright post 50 thereto. Such securement can be effected before or after securement of the plug-in hitch 40 to a hitch receiver. Similarly, the sign box 60 (or a sign 12) and a license plate 06 can be secured to the upright post 50 before or after securement of the upright post 50 to the plug-in hitch 40. FIG. 3 illustrates upright post 50 with neither a sign nor a license plate secured thereto, FIG. 6 illustrates the upright post 50 with a license plate 06 secured thereto, and FIG. 7 illustrates the upright post 50 with a license plate 06 and the sign box 60 secured thereto.

FIG. 7 illustrates how the upright post 50 can be disposed between opposed walls or plates of the plug-in hitch 40. The upright post 50 and plug-in hitch 40 are configured such that, when the upright post 50 is so disposed, openings 52,54 of the upright post 50 align with openings 42,44 of the plug-in hitch 40.

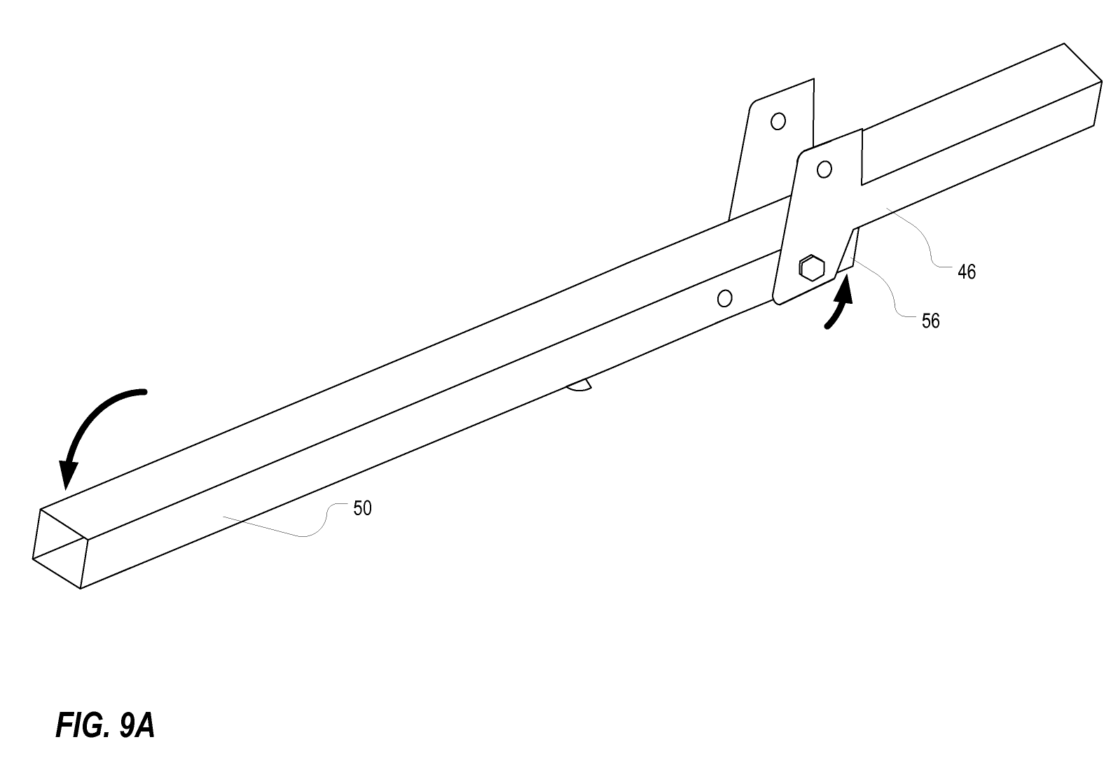

The upright post 50 can then be secured to the plug-in hitch 40 via use of one or more securement members 45, such as a bolt or quick pin, as illustrated in FIG. 8, in which a securement member 45 is disposed within the openings 44 of the plug-in hitch 40 and the openings 54 of the upright post 50.

Importantly, securement via the lower openings 44,54 without similar securement via the upper openings 42,52 allows for rotative movement of the upright post 50 relative to the plug-in hitch 40, as illustrated via arrows in FIG. 8.

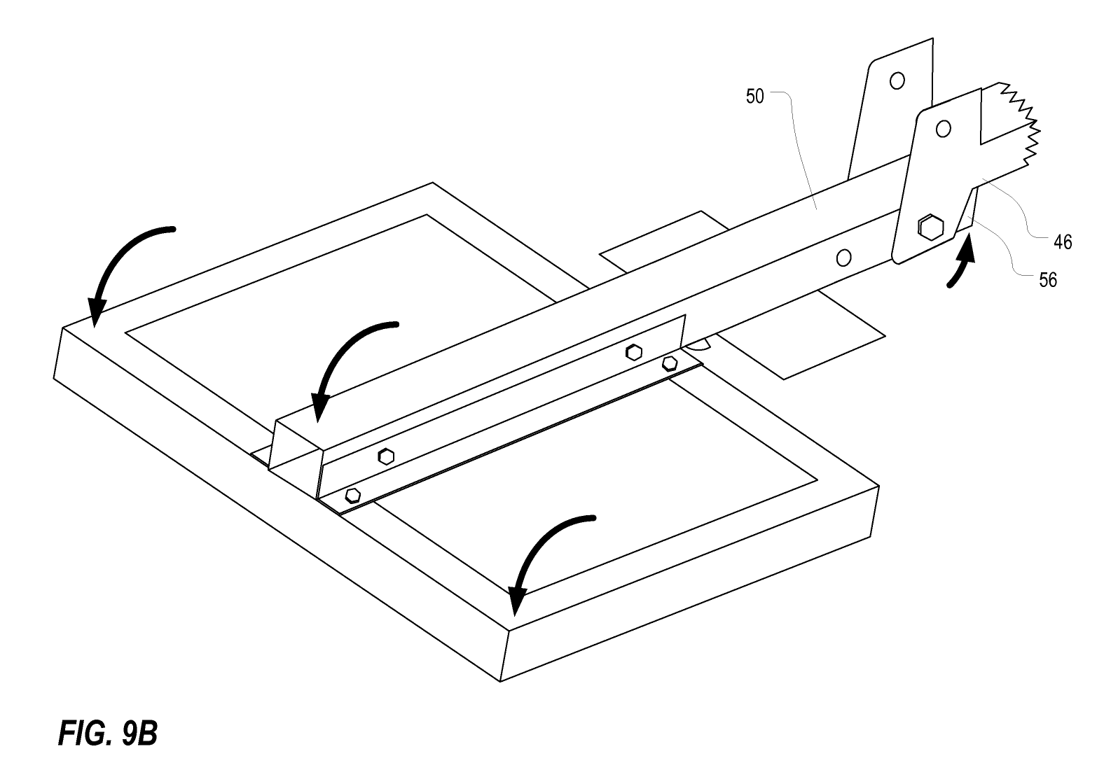

Preferably, the upright post 50 can be rotated all the way down to be generally parallel with an insert portion 46 of the plug-in hitch 40. More preferably still, for the sake of safety, the upright post 50 and plug-in hitch 40 are configured such that, when the upright post 50 is so rotated, the upright post 50 is prevented from rotating past generally parallel with the insert portion 46 of the plug-in hitch 40 by abutment of a lower portion 56 of the upright post 50 with the insert portion 46 of the plug-in hitch 40, as illustrated in FIG. 9A (in which the sign box 60 and license plate 06 are omitted for clarity) and FIG. 9B (in which the sign box 60 and license plate 06 are illustrated).

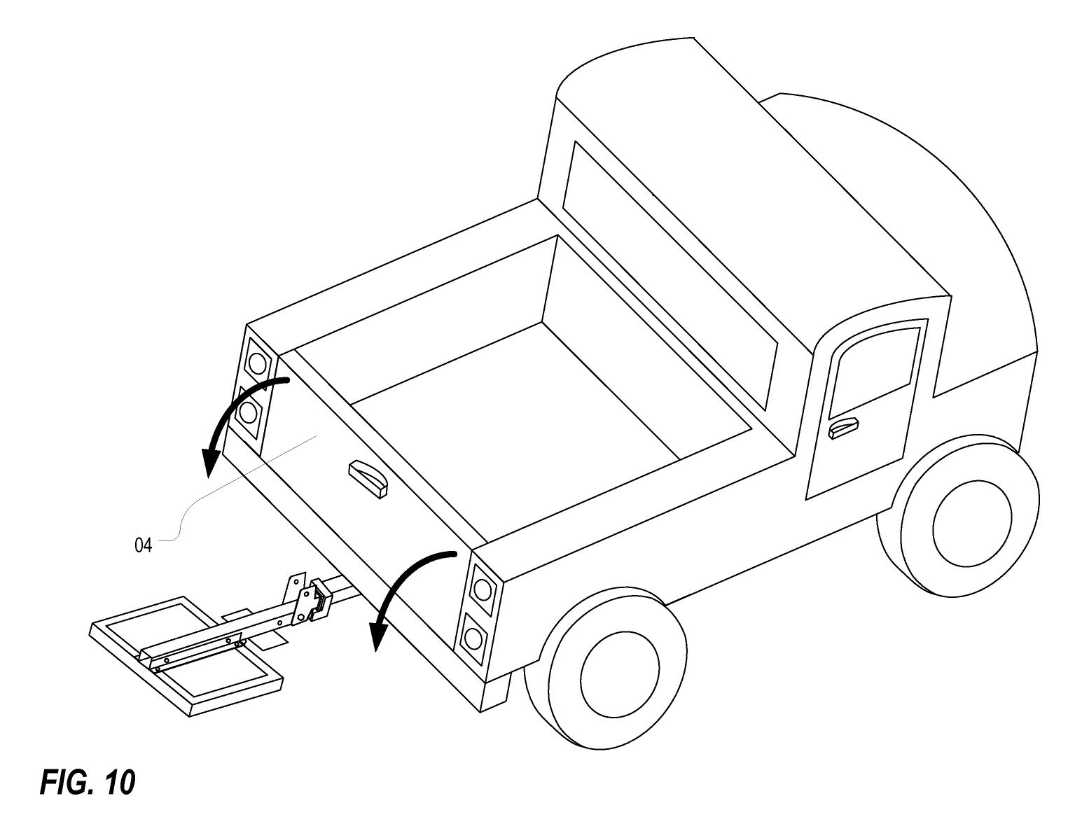

In preferred implementations, the signage apparatus 10 is configured so that such rotatability of the upright post 50 enables the signage apparatus 10 to be rotated downward allowing for the opening of a tailgate, hatch, trunk lid, or rear window or door of a vehicle the signage apparatus 10 is mounted to. For example, returning to the example of the truck 02, when the signage apparatus 10 is attached to the truck 02, the upright post 50 can be rotated downward to allow for opening of the tailgate 04 of the truck 02, as illustrated in FIG. 10.

Further, in preferred implementations, the signage apparatus 10 is preferably configured, for example is sized and dimensioned, to prevent occlusion or blocking of sensors disposed proximate a rear of a vehicle the signage apparatus 10 is to be attached to, such as, for example, a rear-view camera for backing up, or sensors for detecting the presence or proximity of objects near the rear of the vehicle. In some preferred implementations, a signage apparatus is configured to only block, or occupy, a central vertical corridor less than a foot across extending generally upward from the hitch, so as to avoid blocking any such sensors.

As noted hereinabove, the signage apparatus 10 is configured to allow for securement, and display, of a license plate. In one or more preferred implementations, the signage apparatus includes a lighted license plate holder configured for securement of a license plate thereto, the license plate holder being lighted by a 12 v DC fixture. In some preferred implementations, such fixture represents a standard trailer replacement part for a license plate connection.

The sign box 60 is configured to receive and retain a sign therein. In preferred implementations, the sign box 60 is a lighted sign box and is configured to be water-resistant.

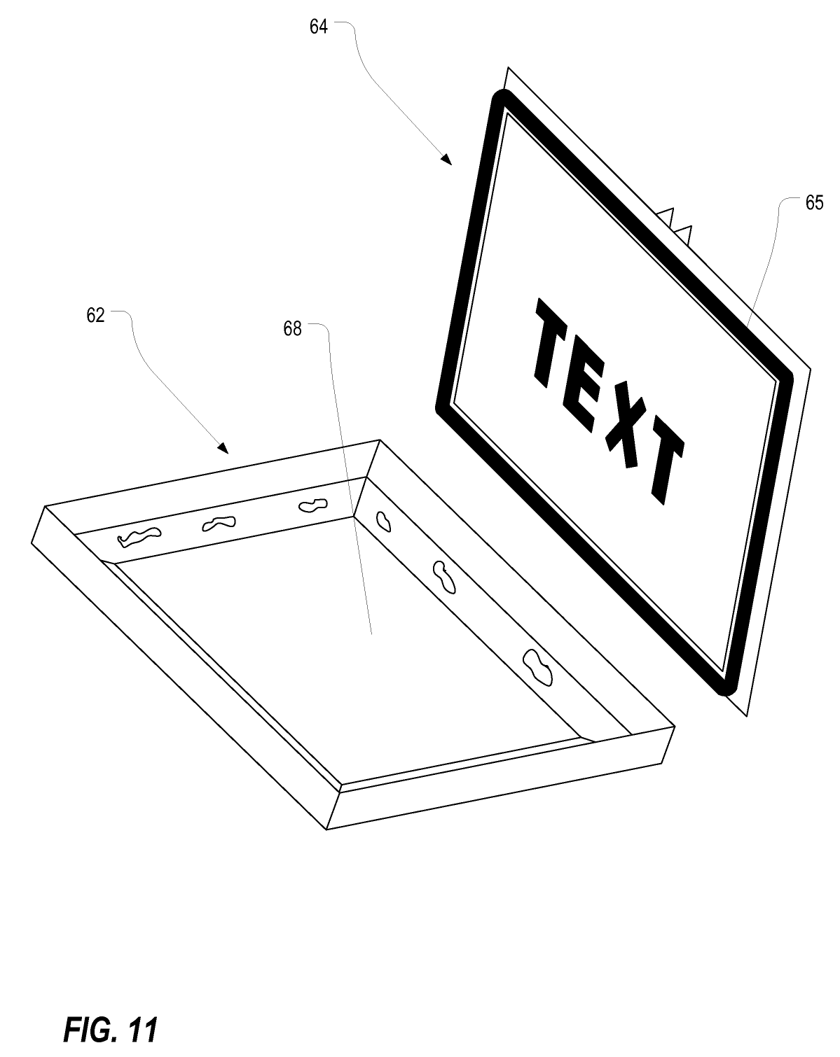

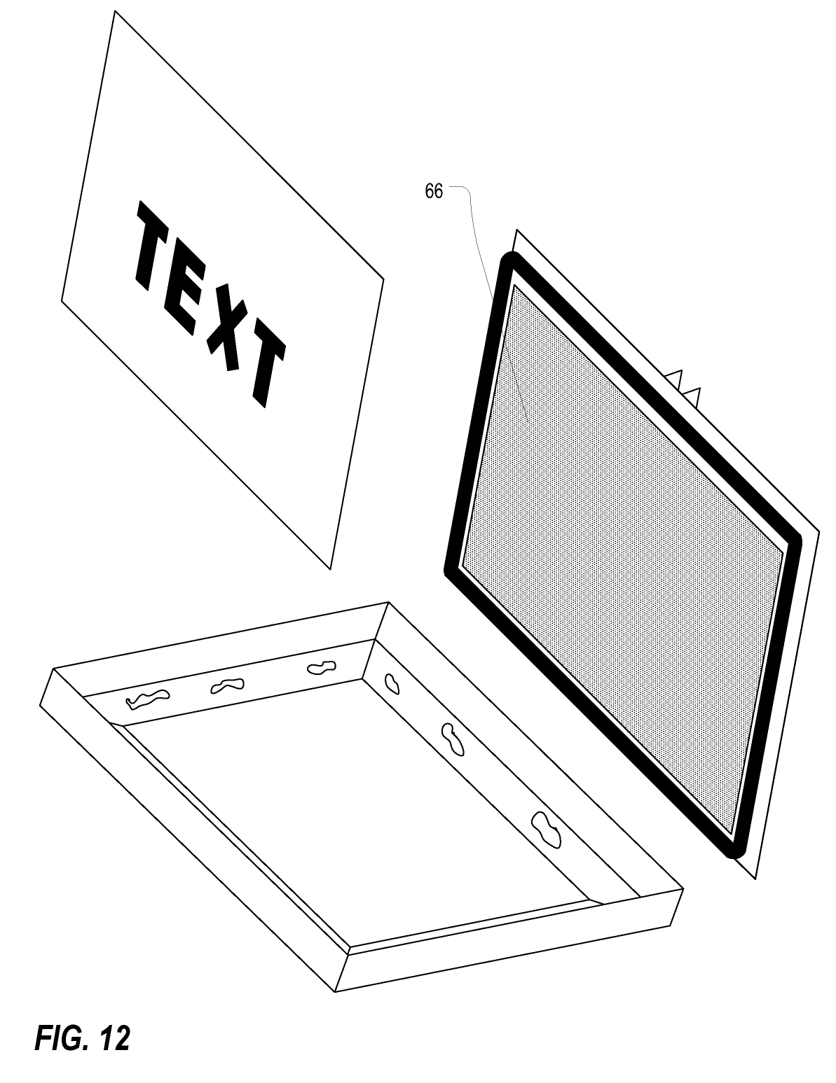

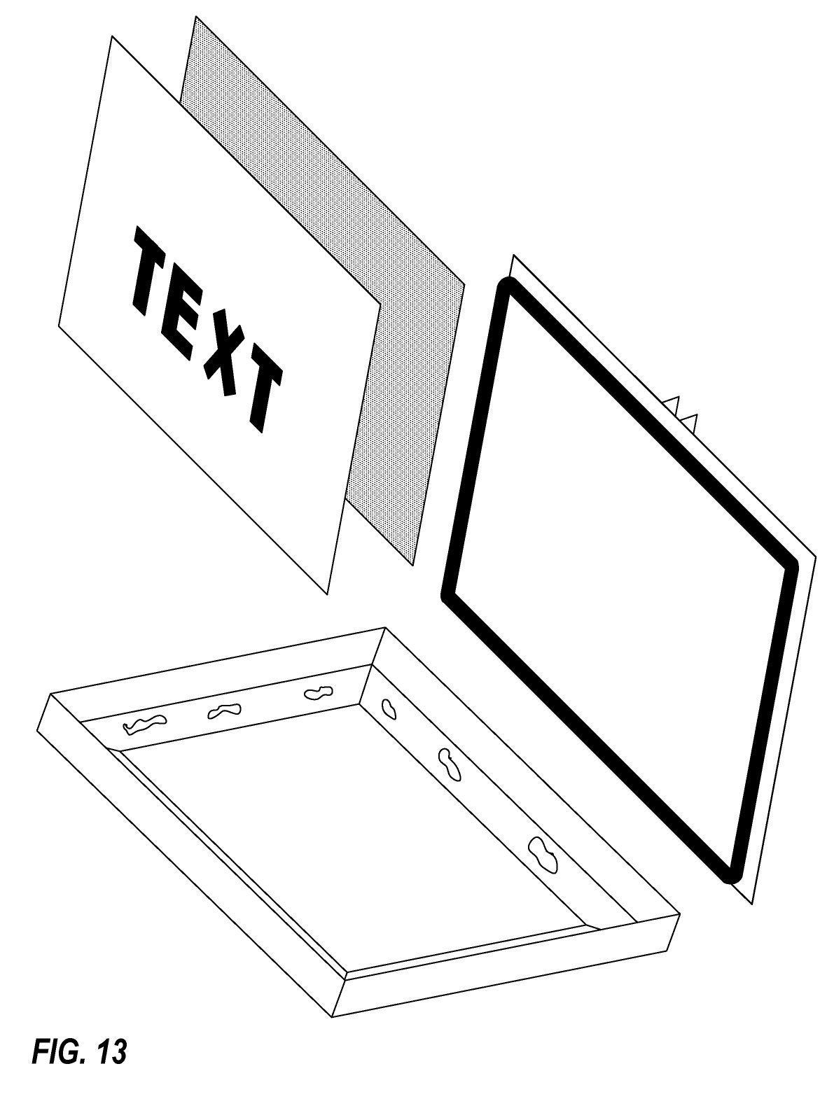

FIG. 11 illustrates the sign box 60 after a lid 62 has been removed from a base 64 of the sign box 60. FIG. 12 illustrates the open sign box 60 after the sign previously disposed therein has been removed, revealing a lighting element 66 received therein. In some preferred implementations, the lightning element 66 is an LED light panel, but in other implementations the lighting element may comprise another type of lightning element. FIG. 13 illustrates the open sign box 60 after the lighting element 66 has been removed.

The base 64 of the sig box 60 preferably comprises a 1×1″ aluminum T with a sheet of aluminum glued thereto on the inside of the frame, as illustrated in FIG. 13. A waterproof seal 65, such as a rubberized sealing strip, is preferably mounted onto the T, as illustrated in FIG. 11.

The lid 62 of the sign box 60 preferably comprises an aluminum frame with a sheet 68 of generally clear polycarbonate resin thermoplastic such as, for example, a clear sheet of Lexan, glued thereto, as illustrated in FIG. 11. Preferably, the lid 62 is configured such that it both closes against the outside of the base 64 and meets the inner seal 65 to form a water resistant seal at both junctures.

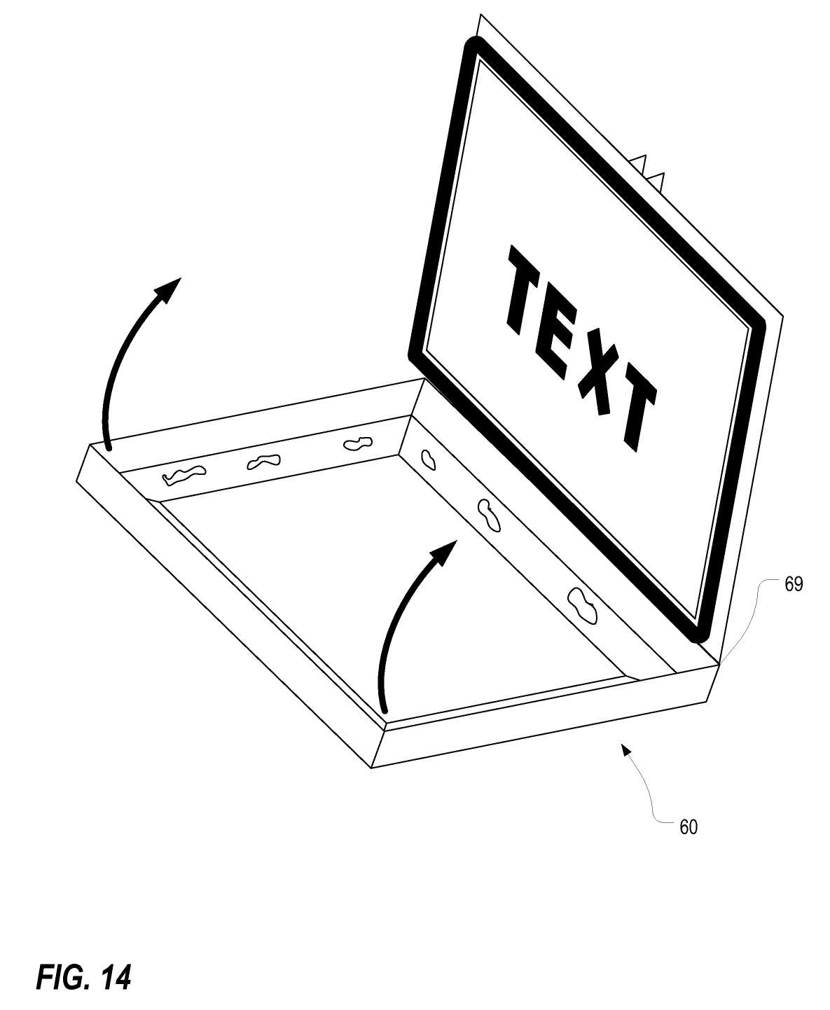

Although illustrated in FIG. 11 as being wholly detachable from the base 64, in one or more preferred implementations the lid 62 is rotatably coupled to the base 64 at a hinge 69 in a manner configured to allow for easy opening and closing of the sign box 60, as illustrated in FIG. 14.

As described hereinabove, the sign box 60 is preferably includes a lightning element, such as, for example, a lightning element configured to backlight a sign disposed therein. In at least some preferred implementations, the sign box 60 includes a power element disposed therein to supply power to the lightning element. Further, in at least some implementations, the sign box 60 alternatively, or additionally, includes wiring and a connector for connection to an external power source, such as, for example, a power connector for a trailer, or a connector for a DC or AC outlet. The sign box 60 preferably is configured for quick connection to such an external power source. In a preferred implementation, a sign box includes a 12 v DC power plug, while in at least some other preferred implementations, a sign box includes a 115 v AC adapter.

In preferred implementations, the sign box 60 preferably includes, on a back side thereof, a mounting channel defined by two L-shaped fastening pieces for receipt of the upright post therein, as can be seen in FIG. 9B.

Although described herein primarily in the context of a sign box 60 for mounting to a vehicle via a hitch receiver and components configured to enable securement via such hitch receiver, in at least some implementations a sign box is configured for use in other contexts as well. For example, a sign box might be configured for use outside of a house, restaurant, bank, or theatre.

More generally, a sign box, either mounted to a vehicle or otherwise supported or displayed, might be utilized to advertise in any of a wide variety of contexts, such as, for example, a real estate context, a taxi context, a business context, or a restaurant context.

Additional disclosure of signage apparatus in accordance with one more embodiments of the present invention is contained in an Appendix hereto in the form of photographs of such signage apparatus. This Appendix is hereby incorporated herein by reference.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1. A signage apparatus comprising:
(a) a plug-in hitch component including
(i) opposed plates, the opposed plates each including a plurality of openings defined therethrough sized and dimensioned for receipt of a securement member, the plurality of openings including a top opening and a bottom opening,
(ii) an insert portion configured for receipt within a hitch receiver,
(iii) wherein the opposed plates extend substantially above a top of the insert portion and the top opening of each plate is disposed above the top of the insert portion, and
(iv) wherein the opposed plates further extend substantially below a bottom of the insert portion, and the bottom opening of each plate is disposed below the bottom of the insert portion,
(v) wherein the opposed plates each include
(A) a front edge, the front edges collectively defining a front gap therebetween,
(B) a top edge extending from the front edge, the top edges collectively defining a top gap therebetween,
(C) a bottom edge extending from the front edge, the bottom edges collectively defining a bottom gap therebetween,
(D) a rear upper edge extending between the top edge and the insert portion, the rear upper edges collectively defining a rear upper gap,
(E) a rear lower edge extending between the bottom edge and the insert portion, the rear lower edges collectively defining a rear lower gap,
(vi) wherein the top gap, bottom gap, rear upper gap, and rear lower gap collectively combine to form a collective gap between the opposed plates extending all the way around except for the portion of the collective gap blocked by the insert portion;
(b) a slack adjuster bracket component including a first securement bolt configured for use in securing the slack adjuster bracket to the hitch receiver, and a second securement bolt configured for use in securing the slack adjuster bracket component to the plug-in hitch component;
(c) a water-resistant sign box configured for receipt of a sign therein, the water-resistant sign box including
(i) a base comprising a water resistant sealant strip disposed on a first side thereof and a mounting channel defined on a second side thereof,
(ii) a lid rotatively coupled to the base via one or more hinges, the lid comprising a generally transparent protective sheet,
(iii) a lighting element, and
(iv) wherein the water resistant sealant strip is positioned and configured to seal the water-resistant sign box when the water-resistant sign box is closed;
(d) an upright post component
(i) sized and dimensioned to be received both between the opposed plates of the plug-in hitch component and the mounting channel of the water-resistant sign box,
(ii) configured for attachment of the water-resistant sign box thereto following insertion of the upright post into the mounting channel of the water-resistant sign box,
(iii) including a plurality of openings defined therethrough sized and dimensioned for receipt of a securement member, and positioned to correspond to the plurality of openings of the opposed plates of the plug-in hitch component when the upright post component is received between the opposed plates of the plug-in hitch component;
(e) wherein the bottom openings of the opposed plates of the plug-in hitch component and lower openings of the plurality of openings of the upright post component are configured for coupling of the upright post component to the plug-in hitch component via a securement member such that the upright post component is capable of rotative movement relative to the plug-in hitch component about a rotative axis defined by the securement member, the rotative axis being disposed below the insert portion of the hitch component, and such rotative movement being limited by the insert portion of the plug-in hitch component so that the upright post component is transitionable between
(i) a raised position in which the upright post component is disposed generally between the first and second opposed plates and oriented generally vertically, and
(ii) a lowered position in which a back face of a lower end of the upright post component abuts a bottom face of the insert portion of the plug-in hitch component thereby limiting further rotative movement of the upright post component, the upright post component being disposed generally horizontally parallel to the insert portion;
(f) wherein the signage apparatus is configured such that, when the insert portion is received within a hitch receiver of a vehicle, the rotative axis is disposed below a top of the hitch receiver of the vehicle so as to allow the entire upright post component to be disposed below a top of the hitch receiver when the upright post component is rotated to a lowered position.

2. The signage apparatus of claim 1, wherein the lightning element comprises an LED panel.

3. The signage apparatus of claim 1, wherein the water-resistant sign box includes an electrical connector for quick connection of the water-resistant sign box to electrical power.

4. The signage apparatus of claim 1, wherein the water-resistant sign box comprises aluminum.

5. The signage apparatus of claim 1, wherein the mounting channel of the water-resistant sign box is defined by two L-shaped fastening pieces.

6. The signage apparatus of claim 1, wherein the base of the water-resistant sign box comprises a sheet of aluminum glued to an aluminum frame.

7. The signage apparatus of claim 1, wherein the generally transparent protective sheet of the lid of the water-resistant sign box is glued to an aluminum frame of the lid.

8. The signage apparatus of claim 1, wherein the openings sized and dimensioned for receipt of a securement member are sized and dimensioned for receipt of a quick pin.

9. The signage apparatus of claim 1, wherein the openings sized and dimensioned for receipt of a securement member are sized and dimensioned for receipt of a bolt.

10. The signage apparatus of claim 1, wherein the signage apparatus is secured to a vehicle.

11. The signage apparatus of claim 10, wherein the signage apparatus is secured to an SUV.

12. The signage apparatus of claim 10, wherein the signage apparatus is secured to a pickup truck.

13. (canceled)

14. A method, for a system comprising a vehicle and a signage apparatus attached to a hitch receiver of the vehicle, the signage apparatus including a sign box, a plug-in hitch component, and an upright post component, both the plug-in hitch component and upright post component including a plurality of openings configured to allow for coupling of the two components to one another, the openings including lower openings configured to allow for rotative movement of the upright post component relative to the plug-in hitch component about a rotative axis defined by a securement member inserted through the lower openings, the rotative axis being disposed below a bottom of the hitch receiver, the method including:
(a) removing a first securement member disposed through openings other than the lower openings, removal of the first securement member leaving only a second securement member coupling the upright post component and plug-in hitch component together such that the second securement member allows for rotative movement of the upright post component relative to the plug-in hitch component about the rotative axis defined by the second securement member;
(b) rotating the upright post component through an arc until a rear face of a base of the upright post component abuts a lower face of an insert portion of the plug-in hitch component such that, following such rotation, the entire upright post component is disposed below the hitch receiver of the vehicle;
(c) opening an access way at a rear of the vehicle;
(d) closing the access way at the rear of the vehicle;
(e) rotating the upright post component through the arc in reverse until a portion of the rear face of the upright post component is disposed proximate an end of the insert portion of the plug-in hitch component and the upright post component is once again disposed generally upright;
(f) reinserting the first securement member through openings other than the lower openings to secure the upright post component.

15. The method of claim 14, wherein the vehicle comprises a pickup truck, and wherein the access way comprises a tailgate of the pickup truck.

16. The method of claim 14, wherein the access way comprises a tailgate.

17. The method of claim 14, wherein the access way comprises a rear door of the vehicle.

18. The method of claim 14, wherein the access way comprises a rear window of the vehicle.

19. The method of claim 14, wherein the vehicle comprises a hatchback vehicle, and wherein the access way comprises a hatch or rear door of the hatchback vehicle.

20. The method of claim 14, wherein the access way comprises a trunk lid.

21. A signage apparatus comprising:
(a) a plug-in hitch component including
(i) opposed plates, the opposed plates each including a plurality of openings defined therethrough sized and dimensioned for receipt of a securement member, the plurality of openings including a top opening and a bottom opening,
(ii) an insert portion configured for receipt within a hitch receiver,
(iii) wherein the opposed plates extend substantially below a bottom of the insert portion, and the bottom opening of each plate is disposed below the bottom of the insert portion;
(b) a slack adjuster bracket component including a first securement bolt configured for use in securing the slack adjuster bracket to the hitch receiver, and a second securement bolt configured for use in securing the slack adjuster bracket component to the plug-in hitch component;
(c) a water-resistant sign box configured for receipt of a sign therein, the water-resistant sign box including
(i) a base comprising a water resistant sealant strip disposed on a first side thereof and a mounting channel defined on a second side thereof,
(ii) a lid rotatively coupled to the base via one or more hinges, the lid comprising a generally transparent protective sheet,
(iii) a lighting element, and
(iv) wherein the water resistant sealant strip is positioned and configured to seal the water-resistant sign box when the water-resistant sign box is closed;
(d) an upright post component
(i) sized and dimensioned to be received both between the opposed plates of the plug-in hitch component and the mounting channel of the water-resistant sign box,
(ii) configured for attachment of the water-resistant sign box thereto following insertion of the upright post into the mounting channel of the water-resistant sign box,
(iii) including a plurality of openings defined therethrough sized and dimensioned for receipt of a securement member, and positioned to correspond to the plurality of openings of the opposed plates of the plug-in hitch component when the upright post component is received between the opposed plates of the plug-in hitch component;
(e) wherein the bottom openings of the opposed plates of the plug-in hitch component and lower openings of the plurality of openings of the upright post component are configured for coupling of the upright post component to the plug-in hitch component via a securement member such that the upright post component is capable of rotative movement relative to the plug-in hitch component about a rotative axis defined by the securement member, the rotative axis being disposed below the insert portion of the hitch component, and such rotative movement being limited by the insert portion of the plug-in hitch component so that the upright post component is transitionable between
(i) a raised position in which the upright post component is disposed generally between the first and second opposed plates and oriented generally vertically, and
(ii) a lowered position in which a back face of a lower end of the upright post component abuts a bottom face of the insert portion of the plug-in hitch component thereby limiting further rotative movement of the upright post component, the upright post component being disposed generally horizontally parallel to the insert portion;
(f) wherein the signage apparatus is configured such that, when the insert portion is received within a hitch receiver of a vehicle, the rotative axis is disposed below a top of the hitch receiver of the vehicle so as to allow the entire upright post component to be disposed below a top of the hitch receiver when the upright post component is rotated to a lowered position.
